(19) United States
(12) Patent Application Publication
(10) Pub. No.: US 2001/0048540 A1
(43) Pub. Date: Dec. 6, 2001

(54) Optical transmitting device

(75) Inventor: Chitaka Konishi, Minato-ku (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/897,674

(22) Filed: Jul. 2, 2001

Related U.S. Application Data
(63) Continuation of application No. 08/825,104, filed on Mar. 27, 1997, now abandoned.

(51) Int. Cl. H04B 10/00; H04B 10/04

(52) U.S. Cl. 359/180; 359/161

(57) ABSTRACT

An optical transmitting device that compensates for waveform distortion in an optical signal path.. The device has an amplifier for amplifying an optical signal input through an optical transmission line. A plurality of dispersion compensators are used to compensate for various degrees of waveform distortion due to dispersion distortion in the optical transmission line by having different dispersion compensating characteristics. A selection switch selects one of the dispersion compensators and connects the first amplifier output with the selected dispersion compensator. Another amplifier is used to amplify the optical signal output by the selected dispersion compensator.

### CROSS REFERENCE TO RELATED APPLICATIONS

This is a continuation of U.S. patent application Ser. No. 08/825,104, filed Mar. 27, 1997 in the name of Chitaka Konishi entitled OPTICAL TRANSMITTING DEVICE which claims the priority of Japanese Patent Application No. 8-070800, filed Mar. 27, 1996, entitled OPTICAL TRANSMITTING DEVICE, to which a claim of priority is made under the provisions of 35 U.S.C. §119.

### FIELD OF THE INVENTION

This invention relates to an optical transmitting device, and more particularly to an optical transmitting device which has means for compensating waveform distortion caused by dispersion in an optical transmission line in ultra-high speed optical communication system.

### BACKGROUND OF THE INVENTION

In general, a conventional optical transmitting device is composed of an electrical-optical converter and an optical amplifier, where a coded data signal to be repeated is input to the electrical-optical converter and is converted into an optical signal and then the optical signal is amplified by the optical amplifier and is again transmitted to an optical transmission line.

The optical amplifier is composed of an optical fiber for amplification, a semiconductor laser for excitation, an optical coupler which couples light emitted from the semiconductor laser for excitation with optical signal light, an optical isolator etc. The optical signal entering the optical fiber for amplification is optically amplified by the semiconductor laser for excitation and is then output.

For an optical signal with 1.55 μm wavelength band, 1.48 μm or 0.98 μm excitation light is typically used. An erbium-doped optical fiber is generally used as the optical fiber for amplification. The semiconductor laser for excitation is in general driven by using a method that makes continuous light emit by injecting a direct current. For example, this driving method is described in Yasuo Kimura and Masataka Nakazawa, OPTRONICS, No. 11, pp.47-53 (1990).

Meanwhile, in an optical transmitting device used in ultra-high speed (Gb/s region) optical communication system, a dispersion compensating means such as dispersion compensating fiber (DCF) may be used for compensating the waveform distortion due to dispersion in an optical transmission line, in particular, when it is used in a high dispersion region.

However, in this case, since the optical transmission line is actually provided with various transmission distances (fiber lengths), the total dispersion value cannot be always predetermined. Therefore, depending on the transmission distance of the actual transmission line, the optical transmitting device needs to be provided with a dispersion compensating means such as DCF which matches the total dispersion value. Further, if the optical transmission line is changed, the dispersion compensating means such as DCF in the optical transmitting device will have to be changed.

### SUMMARY OF THE INVENTION

Accordingly, it is an object of the invention to provide an optical transmitting device in which a flexible dispersion compensation can be performed according to various dispersion characteristics of optical transmission lines.

According to the invention, an optical transmitting device, comprises:

a plurality of dispersion compensating means for compensating a waveform distortion due to a dispersion distortion of an optical signal in an optical transmission line through which the optical signal is input into the optical transmitting device, wherein the plurality of dispersion compensating means have dispersion compensating characteristics different from each other; and

a selection means for selecting one of the dispersion compensating means and for supplying the optical signal to be repeated with the selected dispersion compensating means.

According to another aspect of the invention, an optical transmitting device, comprises:

a first amplifying means for amplifying an optical signal input through an optical transmission line;

a plurality of dispersion compensating means for compensating a waveform distortion due to a dispersion distortion in the optical transmission line, wherein the plurality of dispersion compensating means have dispersion compensating characteristics different from each other;

a selection means for selecting one of the dispersion compensating means and for supplying output of the first amplifying means with the selected dispersion compensating means, and

a second amplifying means for amplifying optical signal output of the selected dispersion compensating means.

### BRIEF DESCRIPTION OF THE DRAWINGS

The invention will be explained in more detail in conjunction with the appended drawings, wherein:

FIG. 1 is a block diagram showing a conventional optical transmitting device,

FIG. 2 is a block diagram showing an optical transmitting device in a first preferred embodiment according to the invention, and

FIG. 3 is a block diagram showing an optical transmitting device in a second preferred embodiment according to the invention.

### DESCRIPTION OF THE PREFERRED EMBODIMENTS

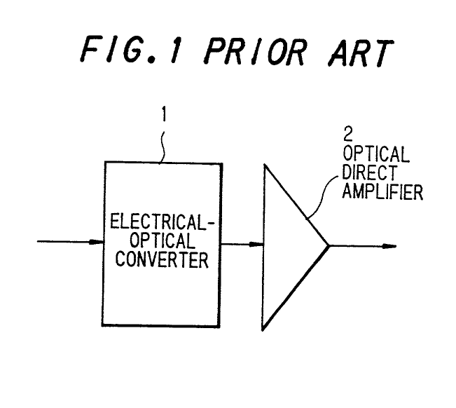

Before explaining an optical transmitting device in the preferred embodiments, the aforementioned conventional optical transmitting device will be explained in FIG. 1. As shown, a coded data signal to be repeated is input to an electrical-optical converter 1 and is converted into an optical signal. Then, the optical signal is amplified by an optical amplifier 2 and is again transmitted to an optical transmission line (not shown).

The optical amplifier 2 is composed of an optical fiber for amplification, a semiconductor laser for excitation, an optical coupler which couples light emitted from the semiconductor laser for excitation with optical signal light, an optical isolator etc. The optical signal entering the optical fiber for amplification is optically amplified by the semiconductor laser for excitation and is then output.

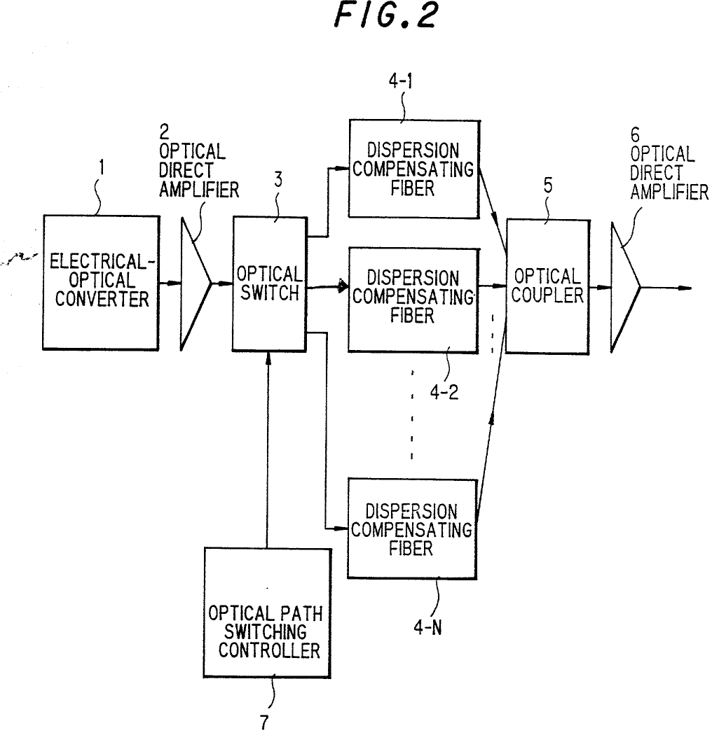

Next, an optical transmitting device in the first preferred embodiment will be explained in FIG. 2, wherein like parts are indicated by like reference numerals as used in FIG. 1.

Referring to FIG. 2, a coded data signal to be repeated is converted into an optical signal by an electrical-optical converter 1. The optical signal is optically direct-amplified by a first optical direct amplifier 2 and is then supplied to an optical switch 3. Applicable to the optical switch 3 are, for example, an optical device such as a semiconductor switch, a temperature sensitive type optical switch (also called a therm-optic switch (TOSW)) and an optical material with electro-optic effect such as lithium niobate (LiNbO3) and lithium tantalate (LiTaO3), which are composed of an optical waveguide with one input port and N(N is an integer of two or more) output ports. Each of the output ports of the optical switch 3 can be selected by an optical path switching controller 7. To the N output ports, N kinds of dispersion compensating fibers 4-1 to 4-N which have dispersion compensating quantities different from each other are connected, thereby being adaptable for various transmission lines.

Next, outputs from the N kinds of dispersion compensating fibers are combined into one signal light by an optical coupler 5, then input to a second optical direct amplifier 6. Signal light output from the optical coupler 5 has a reduced optical level since it has passed through various optical parts. Because of the reduced optical level, the optical direct amplifier 6 is needed to amplify the signal light up to a normal level.

Meanwhile, it is obvious that the first and second optical direct amplifiers 2, 6 may have the same composition as the optical direct amplifier 2 in FIG. 1.

If, in an optical transmission system that employs a 1.55 μm band optical amplifier, an existing 1.3 μm band zero-dispersion single mode fiber is used as the transmission line, deterioration in transmission characteristics may be caused by wavelength dispersion. The 1.3 μm band zero-dispersion single mode fiber has a positive wavelength dispersion. Therefore, an optical fiber which has a negative wavelength dispersion to cancel the positive wavelength dispersion can be used as a dispersion compensating fiber (DCF).

This DCF is 1.55 μm band optical fiber, which is made by, for example, increasing the refractive index distribution of a core and decreasing the diameter of the core to provide the DCF with a negative wavelength dispersion. Then, by providing the obtained DCF with various lengths, it can be used as the dispersion compensating fibers 4-1 to 4-N in FIG. 2. Examples of such kind of DCF are detailed in Technical Report of The Institute of Electronics Information and Communication Engineers, EMD93-42, CPM93-55 OOE93-76 (1993-08), pp. 51-56.

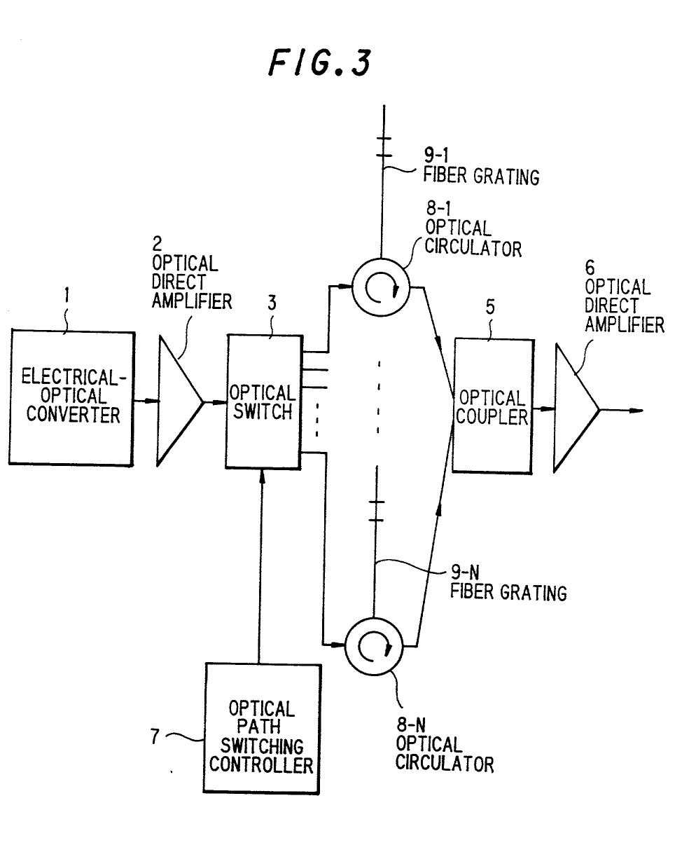

An optical transmitting device in the second preferred embodiment will be explained in FIG. 3, wherein like parts are indicated by like reference numerals as used in FIG. 2.

As shown in FIG. 3, in the second embodiment, N pairs of dispersion compensating means which are composed of optical circulators 8-1 to 8-N and fiber gratings 9-1 to 9-N are used instead of the dispersion compensating fibers 4-1 to 4-N in the first embodiment.

Namely, each of the signal lights output from the output ports of the optical switch 3 is input to one port of any one of the optical circulators 8-1 to 8-N, to the other ports of which the fiber gratings 9-1 to 9-N are connected. Then, signal lights output from further ports of the respective optical circulators 8-1 to 8-N are introduced to the optical coupler 5 to combine them into one signal light. This signal light is, similarly to the first embodiment, optically direct-amplified by the second optical direct amplifier 6, then sent out to an optical transmission line (not shown).

The fiber gratings 9-1 to 9-N are of optical fibers with gratings written on by interference exposure using, e.g., ultraviolet laser light. By providing the gratings with N kinds of pitches (by writing a wavelength difference less than 1 nm on an optical fiber of several tens nm), which are different from each other, dispersion compensating means with various negative dispersion compensating quantities can be obtained.

The signal light supplied to the input port of any one of the optical circulators 8-1 to 8-N enters and passes through corresponding one of the fiber gratings 9-1 to 9-N connected to the other port of the optical circulator, then returning to the same port by reflection. When going and returning through the fiber grating, a phase difference is introduced depending on the grating, thereby enabling the dispersion compensating of signal light.

In the second embodiment, there is an advantage that the dispersion compensating means can be miniaturized as compared to that in the first embodiment using DCF since the lengths of the fiber gratings 9-1 to 9-N can be within several tens nm.

Although the invention has been described with respect to specific embodiment for complete and clear disclosure, the appended claims are not to be thus limited but are to be construed as embodying all modification and alternative constructions that may be occurred to one skilled in the art which fairly fall within the basic teaching here is set forth.

What is claimed is:

1. An optical transmitting device, comprising:
a plurality of dispersion compensating means for compensating for waveform distortion due to dispersion distortion of an optical signal in an optical transmission line through which said optical signal is input into said optical transmitting device, said plurality of dispersion compensating means having dispersion compensating characteristics different from each other, each of said plurality of dispersion compensating means is comprised of an optical circulator, said optical circulator having a plurality of ports, one port of said optical circulator being connected to said optical signal being repeated, and another of said ports being connected to a fiber grating;
a selection means for selecting one of said dispersion compensating means and for supplying said optical signal to be repeated to said selected dispersion compensating means; and
an optical coupler having a plurality of inputs respectively attached to each of said plurality of dispersion compensating means and an output for said optical signal.

2. An optical transmitting device, comprising:
a first amplifying means for amplifying an optical signal input for transmission through an optical transmission line;
a plurality of dispersion compensating means for compensating for waveform distortion due to dispersion distortion in said optical transmission line, said plurality of dispersion compensating means having dispersion compensating characteristics different from each other, each of said plurality of dispersion compensating means is comprised of an optical circulator, said optical circulator having a plurality of ports, one port of said optical circulator being connected to said optical signal being repeated, and another of said ports being connected to a fiber grating;
a selection means for selecting one of said dispersion compensating means and for supplying an output of said first amplifying means to said selected dispersion compensating means;
an optical coupler having a plurality of inputs respectively attached to each of said plurality of dispersion compensating means and an output for said optical signal; and
a second amplifying means for amplifying said optical signal output by said optical coupler.

3. An optical transmitting device, according to claim 1, wherein:
each of said plurality of dispersion compensating means has a dispersion compensating characteristic to cancel said dispersion distortion of said optical transmission line.

4. An optical transmitting device, according to claim 2, wherein:
each of said plurality of dispersion compensating means has a dispersion compensating characteristic to cancel said dispersion distortion of said optical transmission line.

5. An optical transmitting device, according to claim 3, wherein:
each of said plurality of dispersion compensating means is comprised of a dispersion compensating fiber and said dispersion compensating fiber has a dispersion compensating quantity different from each other.

6. An optical transmitting device, according to claim 4, wherein:
each of said plurality of dispersion compensating means is comprised of a dispersion compensating fiber and said dispersion compensating fiber has a dispersion compensating quantity different from each other.

7. An optical transmitting device, according to claim 2, wherein:
said first and second amplifying means are erbium-doped optical fibers.

8. An optical dispersion compensation device, comprising:
a plurality of dispersion compensators effective to provide dispersion compensation in an optical transmission line;
each of said dispersion compensators having compensation characteristics different from each other;
a switch connected to an optical signal source and to said plurality of dispersion compensators;
said switch being operable to transmit an optical signal from said optical signal source to a dispersion compensator based on said compensation characteristics of said dispersion compensator; and
an optical coupler having a plurality of inputs respectively connected to each of said dispersion compensators and having an optical signal output, whereby an optical signal from any of said dispersion compensators is provided to said optical signal output.
